(19) United States
(12) Patent Application Publication
(10) Pub. No.: US 2021/0398000 A1
(43) Pub. Date: Dec. 23, 2021

(54) EXPLAINING RESULTS PROVIDED BY AUTOMATED DECISIONS SYSTEMS

(71) Applicant: SRI International, Menlo Park, CA (US)

(72) Inventors: Grit Denker, Palo Alto, CA (US); Daniel Elenius, Redwood City, CA (US); Karsten Martiny, Milbrae, CA (US)

(21) Appl. No.: 17/304,448

(22) Filed: Jun. 21, 2021

Related U.S. Application Data
(60) Provisional application No. 63/042,078, filed on Jun. 22, 2020.

(51) Int. Cl. G06N 5/04; G06N 5/02

(52) U.S. Cl. CPC G06N 5/045; G06N 5/027

(57) ABSTRACT

In general, the disclosure describes various aspects of techniques for explaining results provided by automated decision systems. A device comprising a memory and a computation engine executing one or more processor may be configured to perform the techniques. The memory may store an automated reasoning engine. The computation engine may execute the automated reasoning engine to obtain a query, obtain, from a knowledge base, and responsive to the query, a knowledge base entity representative of an explicit fact or a rule, and determine, based on the knowledge base entity, the query result that provides a decision to the query. The automated reasoning engine may also obtain provenance information that explains a history for the knowledge base entity, determine, based on the provenance information, an explanation that explains a difference between the query result and a previous query result provided with respect to the query, and output the explanation.

This application claims priority to U.S. Provisional Patent Application No. 63/042,078, entitled “EVOLUTIONARY EXPLANATION AND PROVENANCE TRACING OF RULE-BASED AUTOMATED DECISIONS,” and filed Jun. 22, 2020, the entire contents of which are hereby incorporated by reference in their entirety.

### TECHNICAL FIELD

This disclosure is related to automated decision systems implemented by computing devices.

### BACKGROUND

Automated decision systems may process, according to various rules, information (or, in other words, explicit facts) regarding complicated processes to present a result to a query. Automated decision systems apply the rules to the explicit facts to derive or otherwise obtain implicit facts from which the automated decision system may determine the result value to the query (which may be referred to as a query result value). In some instances, automated decision systems may process large amounts of explicit facts entered by a large number of users across an organization to facilitate medical diagnosis, ensure compliance with regulations (e.g., financial regulations, government regulations, and/or medical regulations), authorize transactions (e.g., loan approvals or acceptance of other types of contracts and/or terms), etc. As such, automated decision systems may, in some instances, process large amounts of explicit facts from diverse and possibly distributed sources to facilitate interoperation through mappings and transformations.

A user of the automated decision system may enter a query that the automated decision system processes to obtain relevant explicit facts to which the automated decision system applies one or more rules in order to obtain a query result value. Given that such automated decision systems may process explicit facts entered by a large number of users, analyzing the result produced by the automated decision system may be difficult, as not only may the explicit facts change over time, but so too may the rules change over time. Users may expect a particular query result value to a query, but receive a query result value from the automated decision system that is contrary to the expectation of the user due to such changes in either facts and/or rules, leaving the users to consume significant amounts of time in order to understand why and how the query result value has changed and thereby validate whether the query result value provided by the automated decision system is correct.

### SUMMARY

In general, the disclosure describes various aspects of techniques for facilitating explanation of query result values provided by automated decision systems. While automated decision systems may provide an explanation of how the query result values are derived or otherwise determined based on explicit facts and various rules stored in a so-called knowledge base (KB) (e.g., rule X was applied to one or more facts, such as fact A), various aspects of the techniques described herein may enable automated decision systems to provide an explanation as to why various query result values have changed over time (e.g., rule X was changed to rule Z, which was then applied to fact A and/or rule X was applied fact B, which is an updated version of fact A). In this respect, the automated decision system that is configured to implement various aspect of the techniques described in this disclosure to output an explanation that provides a provenance (or, in other words, a historical explanation) of how a query result value to a query was determined relative to how a previous query result value was determined in response to the same query entered as a previous time.

The techniques may provide one or more technical advantages to realize at least one practical application. For example, various aspects of the techniques may facilitate user understanding of how the automated decision system determined the current query result value to the query relative to how the automated decision system determined the previous query result value to the same query. This historical explanation provides a provenance of query result value generation that may enable the user to more quickly validate the query result value as accurate and/or correct. Further, the automated decision system may present this historical explanation using natural language to allow users unaccustomed to computer programming languages to more naturally understand the historical explanation.

By enabling the user to more quickly validate and understand the result via the historical explanation, the automated decision system may reduce entry of additional queries that would have otherwise been entered by the user to validate the query result value provided in response to the query. This may improve the user experience, and it may also reduce consumption of underlying computing resources (e.g., processor cycles, memory, memory bandwidth, associated power, etc.). As such, various aspect of the techniques described in this disclosure may enable the underlying computing system to operate more efficiently relative to computing systems that execute automated decision systems that only provide an explanation regarding how the current query result value was provided.

In one example, various aspects of the techniques are directed to a method of explaining a query result value determined by an automated reasoning engine, the method comprising: obtaining, by the automated reasoning engine, a query; obtaining, by the automated reasoning engine, from a knowledge base, and responsive to the query, a knowledge base entity that is representative of one or more explicit facts or one or more rules; determining, by the automated reasoning engine and based on the knowledge base entity, the query result value that provides a decision to the query; obtaining, by the automated reasoning engine, provenance information that explains a history for the knowledge base entity; determining, by the automated reasoning engine and based on the provenance information, an explanation that explains a difference between the query result value and a previous query result value provided with respect to the query; and outputting, by the automated reasoning engine, the explanation.

In another example, various aspects of the techniques are directed to a device configured to explain a query result value determined by an automated reasoning engine, the device comprising: one or more memories configured to store the automated reasoning engine; and a computation engine executing one or more processors, the computation engine configured to execute the automated reasoning engine to: obtain a query; obtain, from a knowledge base, and responsive to the query, a knowledge base entity representative of an explicit fact or a rule; determine, based on the knowledge base entity, the query result value that provides a decision to the query; obtain provenance information that explains a history for the knowledge base entity; determine, based on the provenance information, an explanation that explains a difference between the query result value and a previous query result value provided with respect to the query; and output the explanation.

In another example, various aspects of the techniques are directed to a non-transitory computer-readable storage medium having stored thereon instructions that, when executed, cause one or more processors to execute a computation engine configured to: obtain a query; obtain, from a knowledge base, and responsive to the query, a knowledge base entity representative of an explicit fact or a rule; determine, based on the knowledge base entity, a query result value that provides a decision to the query; obtain provenance information that explains a history for the knowledge base entity; determine, based on the provenance information, an explanation that explains a difference between the query result value and a previous query result value provided with respect to the query; and output the explanation.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example of a system that may be configured to perform various aspects of the explanatory techniques described in this disclosure.

FIGS. 2A and 2B are block diagrams illustrating example construction of the historical explanation based on the proof trees for the current query result value and the previous query result value in accordance with various aspects of the explanatory techniques described in this disclosure.

FIGS. 3A and 3B are block diagrams illustrating another example construction of the historical explanation based on the proof trees for the current query result value and the previous query result value in accordance with various aspects of the explanatory techniques described in this disclosure.

FIG. 4 is a flowchart illustrating example operation of the computation engine of the computing system shown in FIG. 1 in performing various aspects of the explanatory techniques described in this disclosure.

Like reference characters refer to like elements throughout the figures and description.

### DETAILED DESCRIPTION

Automated decision systems, such as so-called “expert systems,” may process a query with respect to a knowledge base (KB) to determine a query result value that represents a decision with regard to the query. In some instances, the expert system may automatically execute the query through application of rules to any new update to the KB. In other words, for certain applications, such as regulatory compliance, the automated decision system may automatically apply rules to a new KB entity stored to the KB to validate that the new KB entity is in compliance, for example, with stated regulations (which are formulated as rules stored to the KB as KB entities).

In any event, the automated decision system may apply certain KB entities (e.g., rules) to other KB entities (e.g., explicit facts) in order to obtain a query result value representative of a decision (e.g., the explicit fact satisfies or fails to satisfy the rule). In some instances, the automated decision system may apply a number of different rules to the explicit facts, in which some of the rules result in implicit facts. As such, the automated decision system may derive, based on KB entities, implicit facts. The automated decision system may then apply rules to the implicit facts to obtain the query result value.

The automated decision system may provide the query result value (e.g., an indication of compliance for a transaction in the instance of financial regulatory compliance) along with an explanation of how the query result value was derived in the form of a so-called “proof tree” of how the result was determined, which may be presented as a structured/formal proof tree and/or as a natural language explanation. The combination of the proof tree (in either structured/formal form or via a natural language explanation) and the query result value may be referred to as a “query result.” The proof tree may include nodes defining the explicit facts, rules, and implicit facts along with edges identifying the relationship between the nodes, thereby providing a visual explanation as to how the result was determined. The natural language explanation may explain how the proof tree was constructed to determine the query result value.

A user of the automated decision system may enter a query that the automated decision system processes to obtain relevant explicit facts to which the automated decision system applies one or more rules in order to obtain or otherwise derive implicit facts and ultimately through recursive application of one or more rules on explicit and/or implicit facts, a query result value to the query. Given that such automated decision systems may process explicit facts entered by a large number of users and implicit facts inferred by a large number of rule applications, analyzing the result produced by the automated decision system may be difficult, as not only may the explicit and/or implicit facts change over time, but so too may the rules change over time. Users may expect a particular result to a query, but receive a query result value from the automated decision system that is contrary to the expectation of the user due to such changes in either facts and/or rules, leaving the users to consume significant amounts of time in order to understand why and how the result has changed and thereby validate whether the result provided by the automated decision system is correct.

Various aspects of the techniques described in this disclosure facilitate explanation of query result values provided by automated decision systems. While automated decision systems may provide an explanation of how the query result values are derived or otherwise determined based on explicit and implicit facts and various rules stored to a so-called knowledge base (KB) (e.g., rule X was applied to one or more facts, such as fact A), various aspects of the techniques described herein may enable automated decision systems to provide an explanation as to why various query result values have changed over time (e.g., rule X was changed or replaced by rule Z, which was then applied to fact A and/or rule X was applied fact B, which is an updated version of fact A). In this respect, the automated decision system that is configured to implement various aspect of the techniques described in this disclosure may output an explanation that provides a provenance (or, in other words, a historical explanation) of how a query result value to a query was determined relative to a how a previous query result value was determined for the query (meaning, the same query).

To enable such a historical explanation, the automated decision system may store provenance information for each KB entity. The KB entity may refer to each explicit fact, and/or rule stored to the KB. Such provenance information may effectively define a change log for each corresponding KB entity (e.g., metadata identifying an author of each change to the KB entity, time of each update to the KB entity, date for each update to the KB entity, before and after values for each KB entity, etc.). Using the provenance information, the automated decision system may recreate results provided at any point in time prior to the current point in time, thereby allowing the automated decision system to recreate previous query results (including the proof tree and/or time-based explanation relative to the current version of the KB recreated via the provenance information) for any point in time prior to the current point in time.

Through the ability to recreate query result values, the automated decision system may generate both the current result (relative to the current state of the KB) and a previous query result (relative to a previous state of the KB) that would be provided with respect to a query (meaning, the same query). Both the current result and the previous result include the proof trees for the corresponding different states of the KB over time, which allows the automated decision system to identify differences in the proof trees for the current query result value and the previous query result value. Based on the differences in the proof trees for the current query result value and the previous query result value, the automated decision system may determine the historical explanation of how the query result value has changed over time, where this historical explanation may indicate that such change occurred as a result of changes to explicit facts, rules, and thus, by implication, also change of implicit facts (due to a rule and/or explicit fact change), etc.

In this way, various aspects of the techniques may facilitate user understanding of how the automated decision system determined the current query result value to the query relative to how the automated decision system determined the previous query result value to the same query. This historical explanation provides a provenance of query result value generation that may enable the user to more quickly validate the result as accurate and/or correct. Further, the automated decision system may present this historical explanation using natural language to allow users unaccustomed to computer programming languages to more naturally understand the historical explanation.

By enabling the user to more quickly validate and understand the result via the historical explanation, the automated decision system may reduce entry of additional queries that would have otherwise been entered by the user to validate the query result value provided in response to the query, which in turn reduces consumption of underlying computing resources (e.g., processor cycles, memory, memory bandwidth, associated power, etc.). As such, various aspect of the techniques described in this disclosure may enable the underlying computing device to operate more efficiently relative to computing devices that execute automated decision systems that only provide an explanation (e.g., a proof tree) regarding how the current query result value was provided.

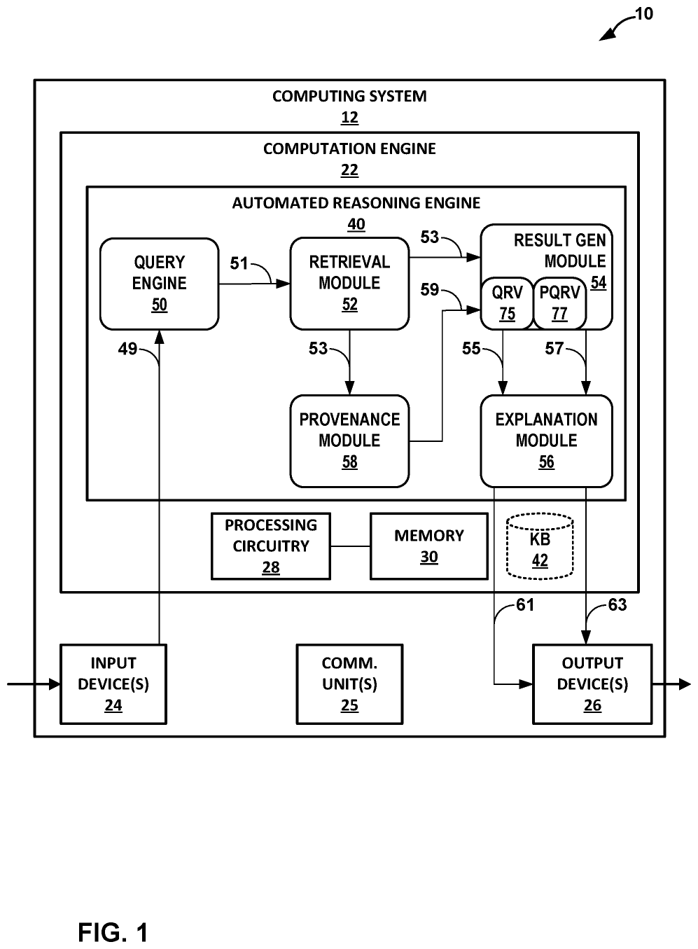

FIG. 1 is a block diagram illustrating an example of a system that may be configured to perform various aspects of the explanatory techniques described in this disclosure. As shown in the example of FIG. 1, system 10 may include a computing system 12. Computing system 12 represents one or more computing devices configured to explain results provided by an automated reasoning system (which is shown as an “automated reasoning engine 40” in the example of FIG. 1) according to various aspects of the techniques described herein.

Computing device 12 may include a computation engine 22, input devices 24, communication units 25, and output devices 26. Computation engine 22 may represent any combination of processing circuitry 28 and memories 30 capable of executing and storing (respectively) automated reasoning engine 40.

Memory 30 may store information for processing during operation of computation engine 22. In some examples, memory 30 may include temporary memories, meaning that a primary purpose of the one or more storage devices is not long-term storage. Memory 30 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Memory 30, in some examples, also includes one or more computer-readable storage media (which may also be referred to as “non-transitory computer-readable media” or “non-transitory computer-readable storage media”). The computer-readable storage media may be configured to store larger amounts of information than volatile memory. The computer-readable storage media may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories. Whether representative of volatile or non-volatile memory, memory 30 may store program instructions and/or data associated with one or more of the modules, units, and/or engines described in accordance with one or more aspects of this disclosure.

Processing circuitry 28 and memory 30 may provide an operating environment or platform for computation engine 22, which may be implemented as software, but may in some examples include any combination of hardware, firmware, and software. Processing circuitry 28 may execute instructions and memory 30 may store instructions and/or data of one or more modules, units, and/or engines. The combination of processing circuitry 28 and memory 30 may retrieve, store, and/or execute the instructions and/or data of one or more applications, modules, units, engines, and/or software. Processing circuitry 28 and memory 30 may also be operably coupled to one or more other software and/or hardware components, including, but not limited to, one or more of the components, unit, and/or engines illustrated in FIG. 1.

Computation engine 22 may perform operations described using software, hardware, firmware, or a mixture of hardware, software, and firmware residing in and/or executing at computing device 12. Computation engine 22 may execute each of the module(s), unit(s), and/or engine(s) with multiple processors or multiple devices. Computation engine 22 may execute one or more of such modules as a virtual machine or container executing on underlying hardware. One or more of such modules may execute as one or more services of an operating system or computing platform. One or more of such modules may execute as one or more executable programs at an application layer of a computing platform.

One or more input devices 24 of computing device 12 may generate, receive, or process input. Such input may include input from a keyboard, pointing device, voice responsive system, video camera (which may also function to capture still images), biometric detection/response system, button, sensor, mobile device, control pad, microphone, presence-sensitive screen, network, or any other type of device for detecting input from a human or machine.

One or more output devices 26 of computing device 12 may generate, transmit, or process output. Examples of output are tactile, audio, visual, and/or video output. Output devices 26 may include a display, sound card, video graphics adapter card, speaker, presence-sensitive screen, one or more USB interfaces, video and/or audio output interfaces, or any other type of device capable of generating tactile, audio, video, or other output. Output devices 26 may include a display device, which may function as an output device using technologies including liquid crystal displays (LCD), quantum dot display, dot matrix displays, light emitting diode (LED) displays, organic LED (OLED) displays, cathode ray tube (CRT) displays, e-ink, or monochrome, color, or any other type of display capable of generating tactile, audio, and/or visual output. In some examples, the display device may include a presence-sensitive display that may serve as a user interface device that operates both as one or more input devices 24 and one or more output devices 26.

One or more communication units 25 of computing device 12 may communicate with devices external to computing device 12 (or among separate computing devices of computing device 12) by transmitting and/or receiving data, and may operate, in some respects, as both an input device and an output device. In some examples, communication units 25 may communicate with other devices over a network. In other examples, communication units 25 may send and/or receive radio signals on a radio network such as a cellular radio network. Examples of communication units 25 include a network interface card (e.g. such as an Ethernet card), an optical transceiver, a radio frequency transceiver, a GPS receiver, or any other type of device that can send and/or receive information. Other examples of communication units 25 may include Bluetooth®, GPS, 3G, 4G, and Wi-Fi® radios found in mobile devices as well as Universal Serial Bus (USB) controllers and the like.

As noted above, computation engine 22 is configured to execute automated reasoning engine 40. Automated reasoning engine 40 represents an example of an automated decision system, such as an automated decision system referred to as “Sunflower.” More information regarding Sunflower can be found in a document entitled “Sunflower—An Integrated Development Environment for Rules and Ontologies and Its Application in Financial Compliance Regulation,” by Denker, et al., published Nov. 13, 2014 by SRI International, the entire contents of which are hereby incorporated by reference as if set forth in its entirety herein. Additional information with regard to Sunflower can also be found in a paper by Ford, et al., entitled “Automating Financial Regulatory Compliance Using Ontology+Rules and Sunflower,” presented at SEMANTiCS, during the Leipzig, Germany meeting dated Sep. 12-15, 2016, the entire contents of which are also hereby incorporated by reference as if fully set forth in its entirety herein.

In any event, automated reasoning engine 40 may implement an expert system, such as a rules-based expert system in which users interact with and validate (or otherwise, confirm) decisions made through processing of facts and rules stored to a knowledge base (KB) 42. In some instances, automated reasoning engine 40 may automatically process data entered into KB 42 as one or more KB entities, where in this fully automated example may result in automated reasoning engine 40 representing a fully automated decision system (which performs all tasks mostly autonomously while some partially automated expert systems require users to confirm or validate all tasks).

In either instance, automated reasoning engine 40 may receive a query 49, which in the example of FIG. 1 is shown as being entered by a user via input devices 24, but may be automatically obtained through rules or other systems responsive to updates performed with respect to KB 42 (e.g., in fully automated decision systems), as such query 49 may have been previously entered and stored for later automatic application due to updates to KB 42. KB 42 may represent a database and/or other structured data store (e.g., a spreadsheet, a document, a comma separated value—CVS—formatted file, etc.). KB 42 may store KB entities (which refers to a data structure) providing one or more, but typically one, of one or more explicit facts and/or one or morerules. KB 42 is shown using dashed lines to reflect that KB 42 may be stored locally, e.g., by memory 30, or accessed remotely (e.g., via communication units 25, which may provide a network connection by which to access KB 42).

As further shown in the example of FIG. 1, automated reasoning engine 40 may include a query engine 50, a retrieval module 52, a result generation module 54, and an explanation module 56. Query engine 50 may represent a module configured to process query 49, which may be provided as a natural language query (in the instance of a non-fully automated decision system, such as the above noted example rule-based expert system), to identify salient facts and connections between such facts represented by query 49. Query engine 50 may, based on the identified facts and connections between such facts, output an unstructured query 51 that is uniform between queries and general to any particular database query language or structure supported by KB 42. Query engine 50 may provide unstructured query 51 to retrieval module 52.

Although described with respect to a user manually inputting query 49, query engine 50 may again itself process previously entered unstructured queries 51 responsive to changes to KB 42. That is, query engine 50 (assuming automated reasoning engine 40 represents a fully automated decision engine) may invoke query engine 50 to monitor updates to KB 42, such that when KB 42 is updated (e.g., by way of a change to a KB entity, removal of a KB entity, or addition of a KB entity), query engine 50 automatically applies existing unstructured query 51 to the updated version of KB 42. As such, the techniques described in this disclosure may also include instances in which unstructured query 51 is reapplied through automatic (potentially rule-based) detection of changes to KB 42. In this sense, receipt of query 49/51 may be triggered through user input, and/or deletion, addition, or modification of KB entities stored in KB 42.

Returning to the example of FIG. 1, retrieval module 52 may represent a module configured to access KB 42 according to particular database query languages (e.g., structured query language—SQL) or particular format (e.g., CSV) responsive to unstructured query 51. Retrieval module 52 may translate unstructured query 51 into a formal query (not shown in the example of FIG. 1 for ease of illustration purposes) that conforms to the structured query language of the databases and/or the retrieval format for accessing various data sources represented by KB 42.

Retrieval module 52 may output this formal query to KB 42 and retrieve one or more KB entities 53 stored to KB 42. Retrieval module 52 may also translate these KB entities into a common format such that all KB entities retrieved by retrieval module 52 provide the same common information associated with the same tags, labels, and/or other identifiers such that such information stored to KB entities retrieved from different sources (which, again, are all represented by KB 42) appear to have a common format despite underlying formats from the different sources that may differ (e.g., in terms of dimensionality, types of data stored, format, etc.). In this respect, KB entities 53 may include translated KB entities and/or untranslated KB entities (where KB entities may not need to be translated when underlying data sources store the KB entities in the common format). Retrieval module 52 may also parse, trim or otherwise modify KB entities 53 that are considered irrelevant, redundant, and/or outdated based on unstructured query 49, external parsing rules (where external again suggests that such rules are “external” to KB 42), or other criteria. Retrieval module 52 may output such KB entities 53 to result generation module 54.

Result generation module 54 (shown in the example of FIG. 1 as “result gen module 54”) may represent a module configured to generate, based on KB entities 53, a query result value (QRV) 75 that is responsive to query 49. When automated reasoning engine 40 represents an example of an expert system, result generation module 54 represents a so-called “inference engine” that applies rules defined by a first set of KB entries 53 to explicit facts defined by a second, different set of KB entries 53 (where the term “set” should be understood to refer to “one or more” elements and not the traditional mathematical definition of set that includes a zero-element—or in other words empty—set, unless indicated otherwise).

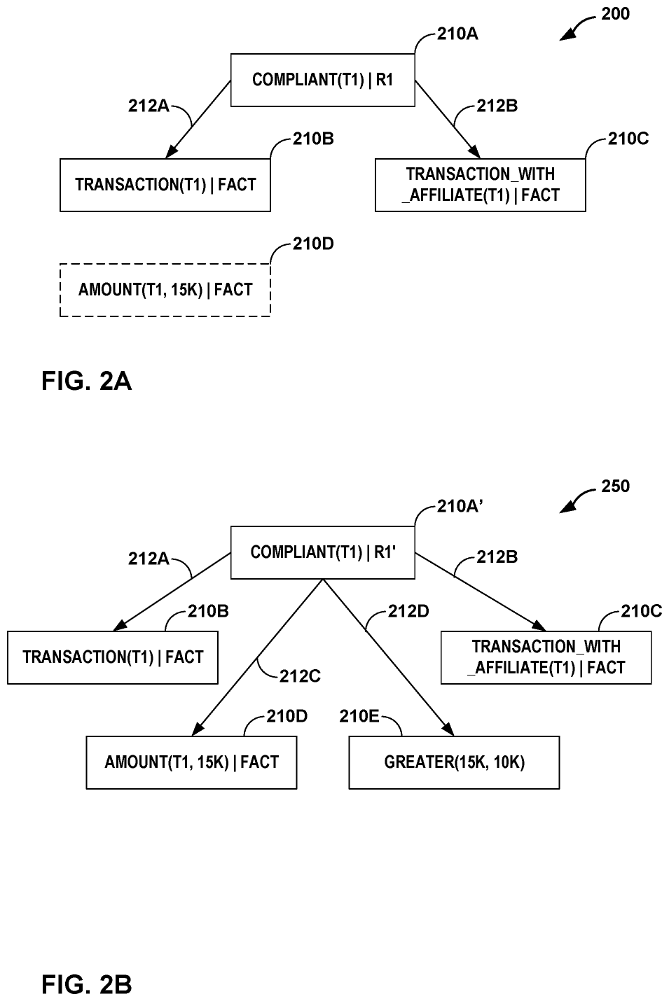

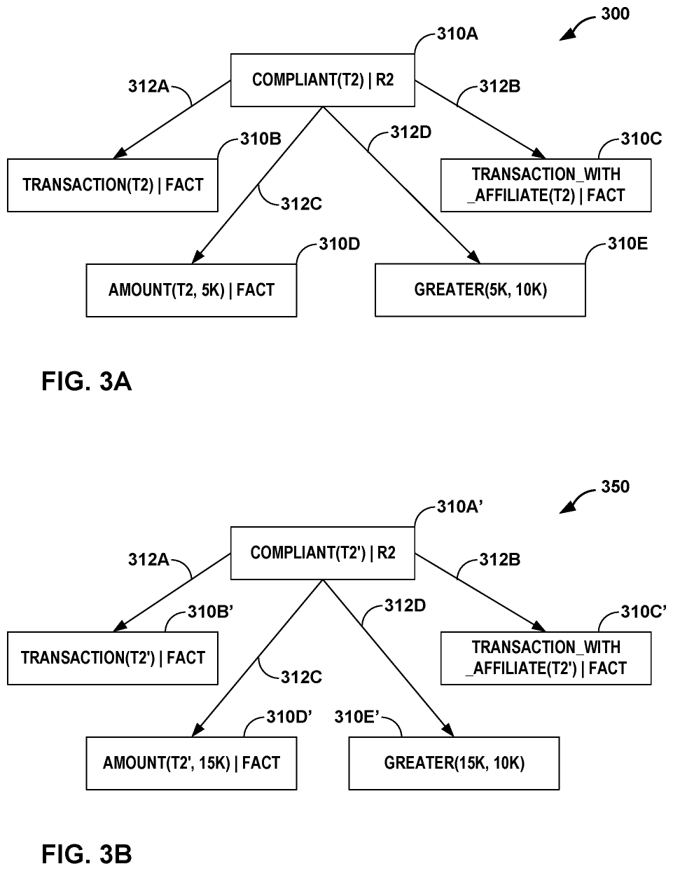

To obtain query result value 75, result generation module 54 may generate a proof tree, which is a logical ordering of KB entities 53 in which the proof tree includes nodes representative of explicit facts, rules, and possibly implicit facts with edges denoting relationships between the nodes. While more information is provided with respect to proof trees in the example of FIGS. 2A-3B, proof trees, briefly, refer to a tree data structure (or, the more general, graph data structure) in which nodes are interconnected by way of edges in order to arrive at query result value 75.

Result generation module 54 may infer or otherwise derive implicit facts through application of rules to explicit facts, updating the proof tree (and possibly KB 42) to include additional nodes (and, in the case of KB 42, additional KB entities) and edges to represent application of a rule node (which is another way of referring to a node that represents a rule) to an explicit fact node (which is another way of referring to a node that represents an explicit fact). Result generation module 54 may continue to construct the proof tree through repeated application of rules to explicit facts (and, in some examples, implicit facts) until result generation module 54 encounters a leaf node from which result generation module 54 may determine query result value 75. Result generation module 54 may therefore present an application programming interface by which KB entities, such as KB entities 53, may be passed to generate query result value 75.

Result generation module 54 may determine query result value 75 as a formal semantic result, which may provide a logically formal decision with respect to unstructured query 51. A user with understanding of database query languages may understand such a formal semantic result but users without extensive understanding of database query languages may not be able to easily understand the formal semantic result. To facilitate user understanding, result generation module 54 may output query result 55 to explanation module 56, where query result 55 may include and the proof tree supporting the formal semantic result (which is another way of referring to query result value 75, and as such may be denoted as formal semantic result 75) along with any other metadata generated while constructing the proof tree and formal semantic result 75.

Explanation module 56 may represent a module configured to translate formal semantic result 75 into a natural language result 61 that includes a natural language explanation of how formal semantic result 75 was obtained based on the current state of KB 42, while also potentially providing a visual (or textual) representation of the proof tree used to generate formal semantic result 75 (which may be interactive and allow the user to inspect KB entities 53 and other aspects of KB 42 used to generate the proof tree). Explanation module 56 may output natural language result 61 via output devices 26 to a user or other operator of computing system 12.

As noted above, a user of automated decision systems may enter a query (e.g., query 49) that the automated decision system processes to obtain relevant explicit facts to which the automated decision system applies one or more rules in order to obtain a result (e.g., result 61) to the query. Given that such automated decision systems may process explicit facts entered by a large number of users, analyzing the result produced by the automated decision system may be difficult, as not only may the explicit facts change over time, but so too may the rules change over time. Users may expect a particular result to a query, but receive a result from the automated decision system that is contrary to the expectation of the user due to such changes in either facts and/or rules, leaving the users to consume significant amounts of time in order to understand why and how the result has changed and thereby validate whether the result provided by the automated decision system is correct.

In accordance with various aspects of the techniques described in this disclosure, automated reasoning engine 40 facilitates increased explanation of query results 55 and/or query result values 75. While automated reasoning engine 40 may provide an explanation of how results are derived or otherwise determined based on explicit facts and various rules stored to KB 42 (e.g., rule X was applied to fact A), various aspects of the techniques described herein may enable automated reasoning engine 40 to provide an explanation 63 as to why various results have changed over time (e.g., rule X was changed to rule Z, which was then applied to fact A and/or rule X was applied fact B, which is an update version of fact A). In this respect, automated reasoning engine 40 that is configured to implement various aspect of the techniques described in this disclosure may output an explanation 63 that provides a provenance (or, in other words, a historical explanation) of how a query result 55 to query 51 was determined relative to a how a previous query result 57 was determined related to query 51 (or, in other words, the same query).

To enable such a historical explanation 63, automated reasoning engine 40 may store provenance information for each KB entity of KB 42 (e.g., in KB 42 with the associated KB entity). Such provenance information may effectively define a change log for each corresponding KB entity (e.g., metadata identifying an author of each change to the KB entity, time of each update to the KB entity, date for each update to the KB entity, before and after values for each KB entity, etc.). Using the provenance information, automated reasoning engine 40 may recreate results provided at any point in time prior to the current point in time, thereby allowing automated reasoning engine 40 to recreate previous results (including the proof tree and/or time-based explanation relative to the current version of the KB recreated via the provenance information) for any point in time prior to the current point in time.

Through the ability to recreate results, automated reasoning engine 40 may generate both the current query result (relative to the current state of the KB, and denoted as query result 55) and a previous result (relative to a previous state of the KB, and denoted as a query result 57) that would be provided with respect to query 51 (meaning, the same unstructured query). Both current query result 55 and previous query result 57 may include the proof trees for the corresponding different states of KB 42 over time, which allows automated reasoning engine 40 to identify differences in the proof trees for current query result value 75 and previous query result value (PQRV) 77. Based on the differences in the proof trees for current query result value 75 and previous query result value 77, automated reasoning engine 40 may determine historical explanation 63 of how result 61 has changed over time, where historical explanation 63 may indicate that such change occurred as a result of changes to explicit facts, rules, implicit facts (due to a rule and/or explicit fact change), etc.

In operation, automated reasoning engine 40 may perform similar to that described above, but include provenance information by which to produce previous query result value 77. As such, automated reasoning engine 40 may invoke query engine 50 to receive natural language query 49 and determine, based on natural language query 49, unstructured query 51. In some examples, as noted above, automated reasoning engine 40 may monitor KB 42 and automatically invoke, responsive to identifying a change to KB 42, query engine 50 to reapply a previously entered unstructured query 51. In either instance, automated reasoning engine 40 may invoke retrieval module 52, which receives unstructured query 51, formulates, based on unstructured query 51, a structured query, and access KB 42 by passing the structured query to KB 42. KB 42 may return one or more KB entities 53 to retrieval module 52. In this way, retrieval module 52 may obtain, from KB 42, and responsive to unstructured query 51, KB entities 53.

Retrieval module 52 may invoke result generation module 54, passing KB entities 53 to result generation module 54. Result generation module 54 may determine, based on KB entities 53, query result value 75 that provides a decision to unstructured query 51 (and natural language query 49 when entered). Result generation module 54 may, as noted above, construct a proof tree to obtain query result value 75 (which may also be referred to a “current query result value 75” throughout this disclosure). Result generation module 54 may include query result value 75 and the proof tree as part of query result 55. Result generation module 54 may invoke explanation module 56, passing query result 55 to explanation module 56, which then translates query result 55 into natural language result 61.

However, rather than just provide natural language result 61, automated reasoning engine 40 may also provide historical explanation 63. To generate historical explanation 63, retrieval module 52 may invoke provenance module 58, passing KB entities 53 to provenance module 58. Provenance module 58 represents a module configured to obtain provenance information that explains a history for the KB entities 53. In some examples, KB entities 53 include provenance information (as part of the underlying data structure). In other examples, provenance module 58 may retrieve the provenance information from KB 42. In either event, provenance information includes metadata that forms what may be considered a change log that documents how each of KB entities 53 has changed over time.

For example, provenance information may indicate that a KB entity of KB entities 53 (where such KB entity may be denoted as KB entity 53A) was created by an author on a given date and time with a given value. The provenance information may next indicate for KB entity 53A that the author (or possibly a different author) changed the given value to an updated value on a different date at a particular time. The provenance information may be structured as a particular data structure, such as a link list, table, CSV list, etc., capable of being sorted across metadata dimensions such that provenance module 58 may analyze provenance information for each of KB entities 53 to identify a proper time and/or date to which to revert current KB entities 53 so as to produce previous KB entities 59.

In other words, provenance module 58 may sort provenance information by date, time, author, and/or other metadata to identify a previous version of KB entities 53. Provenance module 58 may then revert KB entities 53 to the previous date and/or time, potentially changing the current value of KB entities 53 to different values to produce previous KB entities 59. In this example, each value may refer to an explicit fact, and/or rule. Provenance module 58 may invoke result generation module 54, passing previous KB entities 59 to result generation module 54.

Result generation module 54 may perform similar operations to those discussed above with respect to KB entities 53 to produce previous query result 57, which addresses the same query 49 and/or 51, and which includes previous query result value 77 and the corresponding proof tree used to generate previous query result value 77. Result generation module 54 may, in other words, construct a previous proof tree based on previous KB entities 59, analyzing the previous proof tree to produce previous result value 77 (which may also be referred to as “previous query result value 77”). Again, result generation module 54 may generate previous query result 57 to include the previous proof tree. Result generation module 54 may invoke explanation module 56, passing previous result 57 to explanation module 56.

Explanation module 56 may obtain previous query result 57, but rather than generate an explanation for previous query result 57 regarding how previous query result 57 was determined, explanation module 56 may compare previous query result 57 to current query result 55. To compare previous query result 57 to current query result 55, explanation module 56 may traverse the current proof tree and the previous proof tree to identify any differences (e.g., value changes, structural changes in terms of the arrangement of the nodes of the proof trees or edges reflecting dependencies between nodes, etc.). Explanation module 56 may, based on the differences between the current proof tree and the previous proof tree, generate historical explanation 63, which may describe, using natural language (via translation of the differences), the reason for the differences between the current proof tree and the previous proof tree.

In other words, explanation module 56 may determine, based on provenance information (in the sense that previous query result 57 represents an adapted or, in other words, processed version of the provenance information), the difference between current query result 55 and previous query result 57. Explanation module 56 may next translate the difference into historical explanation 63, which explanation module 56 outputs via output devices 26 to the user or another system.

In this way, various aspects of the techniques may facilitate user understanding of how automated reasoning engine 40 determined the current query result 55 to query 51 relative to how automated reasoning engine 40 determined previous query result 57 to query 51. Historical explanation 63 provides a provenance of result generation that may enable the user to more quickly validate result 61 as accurate and/or correct. Further, automated reasoning system 40 may present historical explanation 63 using natural language to allow users unaccustomed to computer programming languages to more naturally understand historical explanation 63.

By enabling the user to more quickly validate and understand result 61 via historical explanation 63, automated reasoning engine 40 may reduce entry of additional queries that would have otherwise been entered by the user to validate result 61 provided in response to query 51, which in turn reduces consumption of underlying computing resources (e.g., processor cycles, memory space, memory bandwidth, associated power, etc.). As such, various aspect of the techniques described in this disclosure may enable underlying computing device 12 to operate more efficiently relative to computing devices that execute automated decision systems that only provide an explanation regarding how the current result was provided.

FIGS. 2A and 2B are block diagrams illustrating example construction of the historical explanation based on the proof trees for the current result and the previous result in accordance with various aspects of the explanatory techniques described in this disclosure. In the example of FIGS. 2A and 2B, explanation module 56 (shown in the example of FIG. 1) may receive proof tree 200 and proof tree 250 as previous query results 57 and current query result 55, where proof tree 200 is included in previous query results 57 and proof tree 250 is included in current query result 55.

That is, result generation module 54 may generate proof tree 200 that includes nodes 210A-210C to identify previous query result value 77. Node 210A may represent a KB entity defining a first rule (R1) specifying a rule for financial compliance of a transaction (T1). The first rule represented by node 210A may specify a condition with regard to whether the transaction (T1) is a transaction with an affiliate than such transaction (T1) is compliant. Node 210B may represent a KB entity defining a fact that transaction T1 is a transaction, while node 210C may represent another KB entity defining that the transaction T1 is associated with an affiliate.

In this example, result generation module 54 may automatically generate proof tree 200 to indicate that node 210A is coupled to nodes 210B and 210C via edges 212A and 212B, where node 210A defines the rule for deciding whether the facts identified by nodes 210B and 210C satisfy the rule defined by node 210A. As such, nodes 210B and 210C are subordinate to node 210A. Result generation module 54 may construct proof tree 200 to identify previous query result value 77 that the transaction T1 represented by nodes 210B and 210C satisfy the rule represented by node 210A. As such, result generation module 54 may output proof tree 200 to enable explanation of previous query result value 77 that transaction T1 represented by nodes 210B and 210C satisfy the rule represented by node 210A.

Provenance module 58 may analyze KB entities represented as nodes 210A-210C to provide these KB entities at a previous time (e.g., before the current time). Provenance module 58 may obtain, based on provenance information stored to each KB entity, a most recent change to each KB entity. Provenance module 58 may next order the changes to each of KB entities represented by nodes 210A-210C and select the most recent change to each of KB entities represented by nodes 210A-210C as the date by which to exclude any changes when providing previous KB entities 59 to result generation module 54 (possibly within some threshold time that controls how far back in time to identify changes). Provenance module 58 may then provide previous KB entities 59 to result generation module 54, which then constructs proof tree 200. In this respect, automated reasoning engine 40 may obtain a first version of the KB entities (which is another way of referring to previous KB entities 59) based on the provenance information associated with each of the KB entities.

Result generation module 54 may also generate proof tree 250 shown in the example of FIG. 2B to identify current query result value 75. Result generation module 54 may generate proof tree 250 that includes node 210A′, which is an updated version of node 210A from proof tree 200 specifying that the first rule has been updated to include an additional criteria that the transaction amount has to have an amount above 10,000 units (e.g., dollars) to be compliant with the financial regulation. The updated first rule is denoted, in the example of FIG. 2B, as rule 1′ (R1′).

As shown in the example of FIG. 2A, there already exists, for previous proof tree 200, a KB entity represented by node 210D indicating an explicit fact that transaction T1 has an amount of 15,000 (15K) units. As R1 has changed most recently, provenance unit 58 selects previous KB entities 59 at the time at which node 210A last changed, thereby providing previous KB entities 59 represented by nodes 210A-210C as previous KB entities 59 for constructing proof tree 200. Nodes 210A′ and 210B-210E represent current KB entities 57 from which result generation module 54 constructs proof tree 250 shown in the example of FIG. 2B.

Proof tree 250 includes nodes 210A′ and 210B-210E. As noted above, node 210A′ represents an updated version of rule 1 (R1′) that specifies a new rule for compliance of financial regulations in which transactions are compliant when performed with an associate and having an amount greater than 10K units. Node 210B and 210C are explicit facts indicating, as noted above and respectively, that transaction T1 is a transaction (an explicit fact) that is with an affiliate (another explicit fact). Node 210D, which was already in KB 42, indicates that transaction T1 has an amount of 15,000 (15K) units).

Result generation module 54 generates node 210E as an intermediate rule that specifies a condition as a part of the rule R1′ in which the amount (15K) of transaction T1 is compared to the R1′ amount (10K) for confirming compliance. Result generation module 54 associates each of nodes 210B-210E to rule 210A′ via edges 212A-212D, outputting proof tree 250 to facilitate further explanation of the provenance of current result 61 relative to previous result 63. In this respect, result generation module 54 may construct proof tree 200 that includes the first version of KB entity as node 210A (or alternatively as an edge should a dependency change) and proof tree 250 that includes a second version of KB entity as node 210A′.

Explanation module 56 may receive both current query result 61 and previous query result 63, each of which includes respective proof trees 250 and 200. Explanation module 56 may next determine, based on proof trees 250 and 200, the difference between current query result 61 and previous query result 63. Explanation module 56 may analyze, in order to identify the difference between current query result 61 and previous query result 63, proof trees 200 and 250, traversing proof trees 200 and 250 to identify any differences between either a node or edge of proof trees 200 and 250.

In the example of FIGS. 2A and 2B, explanation module 56 may determine that rule R1 represented by node 210A has changed relative to the rule R1′ represented by node 210A′ (assuming the change to rule R1 occurred within the threshold time). Explanation module 56 may identify the difference between rule R1 represented by node 210A and rule R1′ represented by node 210A′ by, at least in part, traversing, proof trees 200 and 250 to identify any differences between nodes 201A-210C of proof tree 200 and nodes 210A′ and 210B-210F of proof tree 250.

In some examples, which are not illustrated in the examples of FIGS. 2A and 2B for ease of illustration purposes, explanation module 56 may determine that there is no difference (e.g., when previous proof tree 200 is the same as current proof tree 250 as any changes may not have occurred within the threshold time or such changes did not impact formation of current proof tree 250). In this example, explanation module 56 may determine that previous query result 57 succeeded (in terms of satisfying rule R1) and current query result 55 succeeded (in terms of satisfying the same rule R1, but possibly on different facts). Explanation module 56 may identify this difference in facts providing natural language explanation 61 that both results succeeded but possibly due to the difference in facts. When the underlying facts are the same, explanation module 56 may provide natural language explanation 61 indicating that previous query results 57 are the same as current query results 55.

However, in the examples shown in FIGS. 2A and 2B, explanation module 56 determines that both previous query result 57 succeeded and current query result 55 succeeded but with different proof trees 200 and 250 involving different comparisons as a result of the change of rule R1 to rule R1′. Explanation module 56 may identify this difference between node 210A of previous proof tree 200 and node 210A′ of proof tree 250, while also identifying that current proof tree 250 includes additional nodes 210D (which existed as a fact prior but was not involved in previous proof tree 200 as a result of rule R1 not defining a transaction amount limitation—or in other words, threshold) and 210E.

Explanation module 56 may receive current proof tree 250 and determine that current proof tree 250 includes additional nodes 250D defining an explicit fact that transaction T1 has an amount of 15K units and node 250E that performs a Boolean comparison between the threshold amount in rule R1′ (as represented by node 210A′) of 10K units and the amount of 15K for transaction T1. Current proof tree 250 indicates that transaction T1 is compliant with rule R1′ in that transaction T1 is a transaction (per node 210B) with an affiliate (per node 210C) having an amount of 15K units (per node 210D) that is greater than the threshold amount of 10K units (per node 210E).

As such, explanation module 56 determines that both previous proof tree 200 and current proof tree 250 succeeded but that proof tree 250 succeeded premised upon a different rule R1′ that involved a threshold amount of 10K units in which transaction T1 was compliant in that transaction T1 has an amount of 15K units above the threshold amount of 10K units. Explanation module 56 may then generate natural language explanation 61 providing the explanation to the user that current result 61 succeeded similar to previous result 63 but that such current result 61 succeeded in view of the change of rule R1 to rule R1′ (possibly on a particular date by a particular user) as transaction T1 has an amount of 15K units that exceeds the threshold amount of 10K units defined by rule R1′. Explanation module 56 may output this explanation explaining the difference between current query result 61 and previous query result 63 as a part of current query result 61.

FIGS. 3A and 3B are block diagrams illustrating another example construction of the historical explanation based on the proof trees for the current result and the previous result in accordance with various aspects of the explanatory techniques described in this disclosure. In the example of FIGS. 3A and 3B, explanation module 56 (shown in the example of FIG. 1) may receive proof tree 300 as part of previous query results 57 and proof tree 350 as part of current query results 55.

That is, result generation module 54 may generate proof tree 300 that includes notes 310A-310E to identify previous query result 57. Node 310A may represent a KB entity defining a second rule (R2) specifying a rule for financial compliance of a transaction T2. The second rule R2 represented by node 310A may specify a condition with regard to whether the transaction T2 is a transaction with an affiliate than such transaction T2 is compliant as long as the transaction has an amount greater than a threshold amount of units (e.g., dollars), which in this example is set to 10K units. Node 310B may represent a KB entity defining a fact that transaction T2 is a transaction, while node 310C may represent another KB entity defining that the transaction T2 is associated with an affiliate.

In addition, proof tree 300 may include node 310D that represents a KB entity indicating an amount of 5K units for transaction T2 as an explicit fact. Proof tree 300 also includes a node 310E indicating a Boolean rule that compares the amount of 5K units for transaction T2 to the threshold amount defined by rule R2 of 10K units.

In this example, result generation module 54 may automatically generate proof tree 300 to indicate that node 310A is coupled to nodes 310B-310E via edges 312A-312D, where node 310A defines the rule for deciding whether the facts identified by nodes 310B-310D satisfy the rule defined by node 310A (as evaluated per node 310E). As such, nodes 310B-310E are subordinate to node 310A. Result generation module 54 may construct proof tree 300 to identify previous query result 57 that the transaction T2 represented by nodes 310B-310E satisfy the rule represented by node 310A. As such, result generation module 54 may output proof tree 300 to enable explanation of previous query result 57 that transaction T2 represented by nodes 310B-310D satisfy the rule represented by node 310A as evaluated per node 310E.

Provenance module 58 may analyze KB entities represented as nodes 310A-310E to provide these KB entities at a previous time (e.g., before the current time) in a manner similar to that described above with respect to the KB entities represented by nodes 210A-210D. Provenance module 58 may obtain, based on provenance information stored to each KB entity, a most recent change to each KB entity. Provenance module 58 may next order the changes to each of KB entities represented by nodes 310A-310E and select the most recent change to each of KB entities represented by nodes 310A-310E as the date by which to exclude any changes when providing previous KB entities 59 to result generation module 54 (possibly within some threshold time that controls how far back in time to identify changes). Provenance module 58 may then provide previous KB entities 59 to result generation module 54, which then constructs proof tree 300. In this respect, automated reasoning engine 40 may obtain a first version of the KB entities (which is another way of referring to previous KB entities 59) based on the provenance information associated with each of the KB entities.

Result generation module 54 may also generate proof tree 350 shown in the example of FIG. 3B to identify current result 55. Result generation module 54 may generate proof tree 350 that includes node 310A′, which is an updated version of node 310A from proof tree 300 specifying that the second rule R2 has been applied to an updated version of transaction T2 (which is denoted as transaction T2′) in which the transaction amount has been changed from 5K units to 15K units.

As shown in the example of FIG. 3A, there already exists, for previous proof tree 300, a KB entity represented by node 310D indicating an explicit fact that transaction T2 has an amount of 5K units. As transaction T2 has changed most recently, provenance unit 58 selects previous KB entities 59 at the time at which node 310D last changed, thereby providing previous KB entities 59 represented by nodes 310A-310E as previous KB entities 59 for constructing proof tree 300. Nodes 310A′-310E′ represent current KB entities 57 from which result generation module 54 constructs proof tree 350 shown in the example of FIG. 3B.

Proof tree 350 includes nodes 310A′-310E′. As noted above, node 310A′ represents rule R2 that specifies a new rule for compliance of financial regulations in which transactions are compliant when performed with an affiliate and having an amount greater than 10K units. Node 310A′ however applies the same rule R2 to an updated version of transaction T2′. Node 310B′ and 310C′ are explicit facts indicating, as noted above and respectively, that transaction T2′ is a still a transaction (an explicit fact) that is with an affiliate (another explicit fact). Node 310D′indicates that transaction T2′ now has an amount of 15,000 (15K) units.

Result generation module 54 generates node 310E′ as an intermediate rule that specifies a condition as a part of the rule R2 in which the amount (15K) of transaction T2′ is compared to the rule R2 amount (10K) for confirming compliance. Result generation module 54 associates each of nodes 310B′-310E′ to rule 310A′ via edges 312A-312D, outputting proof tree 350 to facilitate further explanation of the provenance of current result 61 relative to previous result 63. In this respect, result generation module 54 may construct proof tree 300 that includes the first version of KB entity as node 310D (or alternatively as an edge should a dependency change) and proof tree 350 that includes a second version of KB entity as node 310D′.

Explanation module 56 may receive both current result 61 and previous result 63, each of which includes respective proof trees 350 and 300. Explanation module 56 may next determine, based on proof trees 350 and 300, the difference between current query result 61 and previous query result 63. Explanation module 56 may analyze, in order to identify the difference between current query result 61 and previous query result 63, proof trees 300 and 350, traversing proof trees 300 and 350 to identify any differences between either a node or edge of proof trees 300 and 350.

In the example of FIGS. 3A and 3B, explanation module 56 may determine that rule R2 represented by node 310A has changed relative to application of the rule R2 represented by node 310A′ in terms of being applied to an updated transaction T2′. Explanation module 56 may identify the difference between rule R2 represented by node 310A and rule R2 represented by node 310A′ by, at least in part, traversing, proof trees 300 and 350 to identify any differences between nodes 310A-310E of proof tree 300 and nodes 310A′ -310E′ of proof tree 350.

In this example, explanation module 56 may determine that previous result 57 failed (in terms of satisfying rule R2) and current query result 55 succeeded (in terms of satisfying the same rule R2, but possibly on different facts, such as the change in the transaction amount for transaction T2′ in this example). Explanation module 56 may identify this difference in facts providing natural language explanation 61 that previous query results 57 failed while current query results 55 succeeded due to the difference in facts (e.g., the transaction amount for updated transaction T2′ exceeded the threshold amount specified by rule R2 while the previous transaction amount for transaction T1 was below the threshold amount specified for rule R2). When the underlying facts are different, explanation module 56 may provide natural language explanation 61 indicating that previous query results 57 are different than current query results 55. For example, natural language explanation 61 may identify a date of the change, a user who changed the fact, a previously applied fact and the current applied fact, a difference between the previously applied fact and the current applied fact, and any other provenance information useful in explaining a history for the knowledge base entity and this change of result.

In this respect, explanation module 56 may, when previous query results 57 are non-empty, process previous query results 55, analyzing previous proof tree 200/300 (of which there may be more than one proof tree for previous query results 55, although not explicitly shown in the examples of FIGS. 2A and 3A). Explanation module 56 may trace previous proof tree 200/300 to determine whether each of proof tree 200/300 is successful. Explanation module 56 may also analyze, when current query results 55 are non-empty, current proof trees 250/350 (where again current query results 55 may include one or more proof trees although shown as a single proof tree in the examples of FIGS. 2B and 3B), tracing current proof trees 250/350 to identify whether such current query results 55 are successful.

In either instance of current query results 55 and/or previous query results 57, explanation module 56 identifies that current query results 55 and/or previous query results 57 fail (when tracing respective current proof trees 250/350 and/or previous proof trees 200/300), explanation module 56 may request additional proof trees in which automated reasoning engine 40 attempts to identify a different proof tree for the same result (e.g., previous query result 57 and/or current query result 55). Explanation module 56 may identify two successful (but different) proof trees 200/250 in the manner described above with respect to the examples shown in FIGS. 2A and 2B. Explanation module 56 may identify a failed proof tree 300 and a successful proof tree 350 in the examples of FIGS. 3A and 3B.

Explanation module 56 may, for each KB entity represented in proof trees 250/350 that is not in previous proof trees 200/300, retrace previous proof trees 200/300 to identify that such previous query results 57 failed. When previous query results 57 and current query results 55 are empty (or no for Boolean queries), explanation module 56 may pick a proof tree from either previous query results 57 or current query results 55. If a trace of a selected proof tree (e.g., either previous proof trees 200/300 or current proof trees 250/350) does not result in a success on the other proof tree (e.g., current proof trees 250/350 or previous proof trees 200/300), explanation module 56 may determine that no change has occurred. If a trace of a selected proof tree (e.g., either previous proof trees 200/300 or current proof trees 250/350) does not result in a success on the other proof tree (e.g., current proof trees 250/350 or previous proof trees 200/300) but for a different failure, explanation module 56 may determine that an explanation regarding the difference occurred.

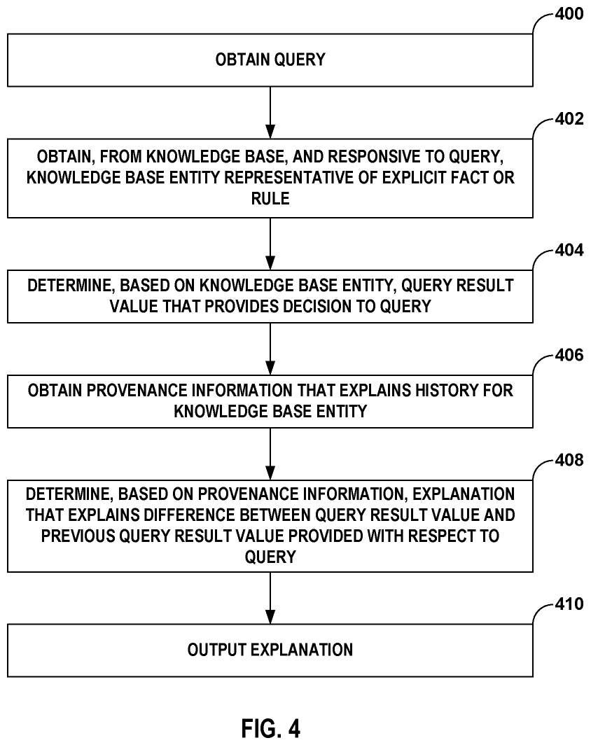

FIG. 4 is a flowchart illustrating example operation of the computation engine of the computing system shown in FIG. 1 in performing various aspects of the explanatory techniques described in this disclosure. Computation engine 22 may first obtain query 49 (400). Computation engine 22 may next obtain, from knowledge base 42, and responsive to query 49, knowledge base entity 53 representative of an explicit fact or a rule (402).

Computation engine 22 may then determine, based on knowledge base entity 53, query result value 75 that provides a decision to query 49 (404). Computation engine 22 may obtain provenance information that explains a history for knowledge base entity 53 (where knowledge base entity 53 may itself include such provenance information as described above in more detail) (406). Computation engine 22 may determine, based on the provenance information, explanation 63 that explains a difference between query result value 75 and a previous query result value 77 provided with respect to query 49 (or, in other words the same query) (408). Computation engine 22 may then output explanation 63 (410).

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a non-transitory computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method of explaining a query result value determined by an automated reasoning engine, the method comprising:
obtaining, by the automated reasoning engine, a query;
obtaining, by the automated reasoning engine, from a knowledge base, and responsive to the query, a knowledge base entity that is representative of one or more explicit facts or one or more rules;
determining, by the automated reasoning engine and based on the knowledge base entity, the query result value that provides a decision to the query;
obtaining, by the automated reasoning engine, provenance information that explains a history for the knowledge base entity;
determining, by the automated reasoning engine and based on the provenance information, an explanation that explains a difference between the query result value and a previous query result value provided with respect to the query; and
outputting, by the automated reasoning engine, the explanation.

2. The method of claim 1, wherein determining the explanation comprises:
determining, based on the knowledge base entity and the provenance information, the difference between the query result value and the previous query result value; and
translating the difference into the explanation that explains the difference between the query result value and the previous query result value.

3. The method of claim 2, wherein determining the difference comprises:
obtaining, based the provenance information, a first version of the knowledge base entity and a second version of the knowledge base entity;
determining, based on the first version of the knowledge base entity, the previous query result value;
determining, based on the second version of the knowledge base entity, the query result value; and
determining at least one of 1) the difference between the query result value and the previous query result value 2) a lack of existence of the knowledge base entity at a time of processing the previous query, and 3) addition of the knowledge base entity at a time after processing the previous query.

4. The method of claim 3, wherein determining the difference comprises:
constructing a first proof tree that includes the first version of knowledge base entity as a first node or a first edge;
constructing a second proof tree that includes the second version of the knowledge base entity as a second node or a second edge; and
determining, based on the first proof tree and the second proof tree, the difference between the query result value and the previous query result value.

5. The method of claim 4, wherein determining the difference comprises determining that the first version of the knowledge base entity has changed relative to the second version of the knowledge base entity.

6. The method of claim 4,
wherein the previous query result value is the same as the query result value, and
wherein determining the difference comprises traversing the first proof tree and the second proof tree to identify that at least one node or edge of the first proof tree is different than a corresponding node or edge of the second proof tree.

7. The method of claim 4,
wherein the provenance information comprises first provenance information,
wherein constructing the first proof tree includes:
applying the first version of the knowledge base entity to a first version of different knowledge base entity determined using second provenance information to obtain a new knowledge base entity representative of an implicit fact, the first version of the different knowledge base entity occurring at a concurrent time as the first version of the knowledge base entity; and
adding a new node to the first proof tree that is representative of the new knowledge base entity.

8. The method of claim 4,
wherein constructing the first proof tree includes:
deriving, from the first version of the knowledge base entity, a first version of an implicit fact; and
adding the first version of the implicit fact to the first proof tree as a first additional node, and
wherein constructing the second proof tree includes:
deriving, from the second version of the knowledge base entity, a second version of the implicit fact; and
adding the second version of the implicit fact to the second proof tree as a second additional node.

9. The method of claim 1, wherein the provenance information includes data identifying one or more of a creator of the knowledge base entity, a time at which the knowledge base entity was created or changed, a date at which the knowledge base entity was created or changed, and a reason indicating why the knowledge base entity was created or changed.

10. The method of claim 1, wherein the explanation further explains a history of change that resulted in the difference between the query result value and the previous query result value.

11. The method of claim 1,
wherein obtaining a knowledge base entity comprises obtaining a first knowledge base entities that is representative of a rule and a second knowledge base entity that is representative of an explicit fact, and
wherein determining the query result value includes:
deriving, based on application of the first knowledge base entity to the second knowledge base entity, an implicit fact; and
determining, based on the implicit fact, the query result value.

12. A device configured to explain a query result value determined by an automated reasoning engine, the device comprising:
one or more memories configured to store the automated reasoning engine; and
a computation engine executing one or more processors, the computation engine configured to execute the automated reasoning engine to:
obtain a query;
obtain, from a knowledge base, and responsive to the query, a knowledge base entity representative of an explicit fact or a rule;
determine, based on the knowledge base entity, the query result value that provides a decision to the query;
obtain provenance information that explains a history for the knowledge base entity;
determine, based on the provenance information, an explanation that explains a difference between the query result value and a previous query result value provided with respect to the query; and
output the explanation.

13. The device of claim 12, wherein the computation engine is, when configured to determine the explanation, configured to:
determine, based on the knowledge base entity and the provenance information, the difference between the query result value and the previous query result value; and
translate the difference into the explanation that explains the difference between the query result value and the previous query result value.

14. The device of claim 13, wherein the computation engine is, when configured to determine the difference, configured to:
obtain, based the provenance information, a first version of the knowledge base entity and a second version of the knowledge base entity;
determine, based on the first version of the knowledge base entity, the previous query result value;
determine, based on the second version of the knowledge base entity, the query result value; and
determine at least one of 1) the difference between the query result value and the previous query result value 2) a lack of existence of the knowledge base entity at a time of processing the previous query, and 3) addition of the knowledge base entity at a time after processing the previous query.

15. The device of claim 14, wherein the computation engine is, when configured to determine the difference, configured to:
construct a first proof tree that includes the first version of knowledge base entity as a first node or a first edge;
construct a second proof tree that includes the second version of the knowledge base entity as a second node or a second edge; and
determine, based on the first proof tree and the second proof tree, the difference between the query result value and the previous query result value.

16. The device of claim 15, wherein the computation engine is, when configured to determine the difference, configured to determine that the first version of the knowledge base entity has changed relative to the second version of the knowledge base entity.

17. The device of claim 15,
wherein the previous query result value is the same as the query result value, and
wherein the computation engine is, when configured to determine the difference, configured to traverse the first proof tree and the second proof tree to identify that at least one node or edge of the first proof tree is different than a corresponding node or edge of the second proof tree.

18. The device of claim 15,
wherein the provenance information comprises first provenance information,
wherein the computation engine is, when configured to construct the first proof tree, configured to:
apply the first version of the knowledge base entity to a first version of different knowledge base entity determined using second provenance information to obtain a new knowledge base entity representative of an implicit fact, the first version of the different knowledge base entity occurring at a concurrent time as the first version of the knowledge base entity; and
add a new node to the first proof tree that is representative of the new knowledge base entity.

19. The device of claim 12,
wherein the computation engine is, when configured to obtain the knowledge base entity, configured to obtain a first knowledge base entities that is representative of a rule and a second knowledge base entity that is representative of an explicit fact, and
wherein the computation engine is, when configured to determine the query result value, configured to:
derive, based on application of the first knowledge base entity to the second knowledge base entity, an implicit fact; and
determine, based on the implicit fact, the query result value.

20. A non-transitory computer-readable storage medium having stored thereon instructions that, when executed, cause one or more processors to execute a computation engine configured to:
obtain a query;
obtain, from a knowledge base, and responsive to the query, a knowledge base entity representative of an explicit fact or a rule;
determine, based on the knowledge base entity, a query result value that provides a decision to the query;
obtain provenance information that explains a history for the knowledge base entity;
determine, based on the provenance information, an explanation that explains a difference between the query result value and a previous query result value provided with respect to the query; and
output the explanation.
